(19) United States
(12) Patent Application Publication
(10) Pub. No.: US 2008/0072928 A1
(43) Pub. Date: Mar. 27, 2008

(54) Carbon Dioxide Dry Cleaning

(75) Inventors: Joachim Karthaeuser, Sollentuna (SE); Anders Marcusson, Lidingoe (SE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/596,601

(22) PCT Filed: May 25, 2005
(86) PCT No.: PCT/EP05/05660

§ 371 Date: Aug. 20, 2007

(30) Foreign Application Priority Data
May 27, 2004 (EP) 04012617.9

(51) Int. Cl. B08B 3/10; B08B 5/00

(52) U.S. Cl. 134/10

(57) ABSTRACT

A method for cleaning objects in a cleaning fluid is disclosed. The cleaning fluid initially includes a dense phase gas and water and in a subsequent cleaning step at least part of the water is filtered out of the cleaning fluid.

### BACKGROUND AND SUMMARY OF THE INVENTION

This application claims the priority of International Application No. PCT/EP2005/005660, filed May 25, 2005, and European Patent Application No. EP 04012617.9, filed May 27, 2004, the disclosures of which are expressly incorporated by reference herein.

The invention relates to a method for cleaning objects in a cleaning fluid comprising a dense phase gas and water. Further the invention relates to an apparatus for cleaning objects in a cleaning chamber.

Filtration of dense phase gas, such as liquid carbon dioxide, is carried out in commercial dry cleaning machines in order to avoid accumulation of particulate dirt such as detached fibers in the distillation/recovery part of the dry cleaning machine.

In dry cleaning systems, water is useful as an additive in order to assist the removal of hydrophilic stains. Also, certain useful surfactants exhibit higher solubility in the presence of water than in pure carbon dioxide. It has been speculated that water and surfactants exist in condensed carbon dioxide in the form of reverse micelles, and that these reverse micelles contribute greatly to the observed cleaning effect. However, it is found in practice that water has a high affinity to many materials, such as garments, and is therefore difficult to remove from those. Following a dry cleaning cycle, garments are often wet which requires costly measures for drying.

Among people skilled in the art of dry cleaning with carbon dioxide, sometimes the belief is held that garments following a carbon dioxide dry cleaning process either are clean—in which case they are wet of water—, or they are dry—but in this case they are unlikely to be clean. Therefore, water is added in the practice of dry cleaning because of its beneficial aspects, e.g. in the form of aqueous-based pre-spotters, or surfactants dissolved in water which are introduced directly into the washing drum, and the water is removed later by time-consuming drying.

It is therefore an object of the invention to develop a method for dry cleaning of objects which allows the presence of water during the washing cycle, but which avoids the above described problems that the objects are wet after the washing cycle.

This object is achieved by a method for cleaning objects in a cleaning fluid comprising a dense phase gas and water, wherein at least part of the water is filtered out of the cleaning fluid.

### DETAILED DESCRIPTION OF THE EXEMPLARY EMBODIMENTS

According to the invention the objects are at least temporarily cleaned in a cleaning fluid comprising a dense phase gas and water. Preferably towards the end of the cleaning procedure, at least a fraction of the water is filtered out of the cleaning fluid. It is advantageous to remove essentially all water by filtration. Thus, after the cleaning procedure is finished it is no more necessary to dry the objects. At least, the time needed for drying the objects is minimized.

According to a preferred embodiment the objects are placed in a cleaning chamber and washed with a cleaning fluid comprising a dense phase gas and water. At least a fraction of the cleaning fluid is withdrawn from the cleaning chamber and water is filtered out of the fraction of the cleaning fluid. After the filtration step the filtered cleaning fluid is transferred back to the cleaning chamber.

In one preferred embodiment, the filtration device is placed in a pipe, and the cleaning fluid is pumped through the pipe continuously during the cleaning process whereby water is removed from the cleaning fluid. The pipe may be the pipe which is used for emptying the cleaning fluid into the recovery and distillation vessel. Optionally, the flow through the pipe is supported by pumping. The complete cleaning fluid is pumped through the pipe during the cycle at least once, optionally two, five, fifty or more times.

Preferably the cleaning method comprises at least a step of cleaning the objects in a dense phase gas and water and a step of cleaning the objects in dense phase gas only. Between these two steps the water is filtered out of the cleaning fluid according to the invention.

The filtration of water out of the cleaning fluid is preferably carried out by passing the cleaning fluid through a filtration device which comprises a hygroscopic material, especially a silica gel or a molecular sieve. In particular it is preferred to use a molecular sieve with a pore size between 3 Å and 4 Å.

According to a preferred embodiment the objects are cleaned in a cleaning chamber in a cleaning fluid comprising a dense phase gas and water. At least part of the water is filtered out of the cleaning fluid inside the cleaning chamber. This is preferably achieved by placing a filtration device inside the cleaning chamber.

According to a preferred embodiment the cleaning procedure is started with a cleaning fluid comprising a mixture of a dense phase gas, such as carbon dioxide, with a relative high content of water. The cleaning fluid is continuously passed through the filtration device and thus the water fraction continuously decreases. Towards the end of the cleaning procedure the objects are cleaned essentially in dense phase gas only.

Preferably the filtration device comprises a mechanical filter. The mechanical filter removes fibers, dirt, and other particulate material from the cleaning fluid and protects the hygroscopic material, such as a molecular sieve or a silica gel. In one embodiment, the cleaning chamber comprises a rotating drum. Simple net filters, for example made of steel wire, are arranged on the rotating drum to collect loose fibers during a garment cleaning cycle. The hygroscopic material may be provided on the exterior surface of the rotating drum or in a pipe connected to the cleaning chamber.

The filtration device is ideally constructed in such a manner that it can be easily be changed or replaced.

The cleaning fluid preferably comprises dense phase carbon dioxide in liquid or super-critical state. The cleaning result may be further improved by adding additives, in particular water-soluble additives, to the cleaning fluid.

The invention allows carbon dioxide-dry cleaning in the presence of water, but solves the problem caused by water which is present on carbon dioxide-dry-cleaned garments after the cleaning process. Equally, passing the cleaning fluid many times during the treatment process through a mechanical filter, effectively removes all solid particles, such as loose fibers, mites, and other particulate material, as it were, from the distribution equilibrium. In addition, certain surfactants used for detaching particulates from the substrate to be cleaned, e.g. of cationic type, are removed as well as they are strongly bound to the particulate material.

1-8. (canceled)

9. A method for cleaning objects in a cleaning fluid wherein in a beginning of a cleaning procedure the cleaning fluid comprises a dense phase gas and water, and wherein the water is filtered out of the cleaning fluid, and further wherein towards an end of the cleaning procedure the objects are cleaned essentially in the dense phase gas only.

10. The method according to claim 9, wherein carbon dioxide is used as the dense phase gas.

11. The method according to claim 9, wherein the objects are cleaned in a cleaning chamber and wherein the method further comprises the steps of:
withdrawing part of the cleaning fluid from the cleaning chamber;
filtering water out of the part of the cleaning fluid; and
transferring the filtered cleaning fluid back to the cleaning chamber.

12. The method according to claim 9, wherein the objects are cleaned in a cleaning chamber and wherein at least part of the water is filtered out of the cleaning fluid inside the cleaning chamber.

13. The method according to claim 9, wherein the cleaning fluid is passed through a filtration device wherein the filtration device comprises a hygroscopic material.

14. The method according to claim 13, wherein the hygroscopic material is a silica gel.

15. The method according to claim 13, wherein the hygroscopic material is a molecular sieve.

16. The method according to claim 15, wherein the molecular sieve has a pore size between 3 Å and 4 Å.

17. The method according to claim 13, wherein the filtration device includes a mechanical filter.

18. The method according to claim 9, wherein the cleaning fluid includes additives.

19. The method according to claim 18, wherein the additives are water-soluble additives.

20. A method of cleaning an object in a cleaning fluid, comprising the steps of:
cleaning the object in a first phase of a cleaning procedure in a cleaning fluid including a dense phase gas and an amount of water;
filtering at least a portion of the amount of water out of the cleaning fluid in a second phase of the cleaning procedure to result in a cleaning fluid with the dense phase gas and a reduced amount of water; and
cleaning the object in a third phase of the cleaning procedure in a cleaning fluid including the dense phase gas and the reduced amount of water.

21. The method according to claim 20, wherein the step of filtering at least a portion of the amount of water out of the cleaning fluid removes essentially all of the amount of water from the cleaning fluid.

22. The method according to claim 20, wherein the step of filtering at least a portion of the amount of water out of the cleaning fluid includes the step of passing the cleaning fluid through a filtration device a plurality of times.

23. The method according to claim 22, wherein a remaining amount of water in the cleaning fluid decreases after each pass of the cleaning fluid through the filtration device.

24. The method according to claim 20, wherein the dense phase gas is carbon dioxide.

25. A method of cleaning an object in a cleaning fluid, comprising the steps of:
cleaning the object in a cleaning fluid including a dense phase gas and water;
filtering the water out of the cleaning fluid; and
cleaning the object in the cleaning fluid after the water is filtered out of the cleaning fluid.

26. The method according to claim 25, wherein the step of filtering the water out of the cleaning fluid includes the steps of:
withdrawing the cleaning fluid from a cleaning chamber;
filtering the water out of the withdrawn cleaning fluid; and
returning the withdrawn cleaning fluid back to the cleaning chamber after the water is filtered out of the withdrawn cleaning fluid.

27. The method according to claim 26, wherein the cleaning fluid is withdrawn from the cleaning chamber and returned to the cleaning chamber through a pipe.

28. The method according to claim 27, wherein the step of filtering the water out of the withdrawn cleaning fluid includes pumping the cleaning fluid through a filtration device included in the pipe.
